(19) United States
(12) Patent Application Publication
(10) Pub. No.: US 2026/0228194 A1
(43) Pub. Date: Aug. 6, 2026

(54) SYSTEM AND METHOD FOR DETECTION AND MITIGATION OF BIAS IN DATA

(71) Applicant: Truata Limited, Dublin (IE)

(72) Inventors: Michael Fenton, Greystones (County Wicklow) (IE); Noel Rogers, Dublin (IE)

(73) Assignee: Truata Limited, Dublin (IE)

(21) Appl. No.: 19/043,308

(22) Filed: Jan. 31, 2025

(51) Int. Cl. G06F 16/215; G06F 16/25

(52) U.S. Cl. CPC G06F 16/215; G06F 16/254

(57) ABSTRACT

A system and method that allows for the detection and mitigation of bias with respect to a specified decision outcome field within a dataset to occur are described. This includes a sensitive field detection engine to identify fields identified with a particular type of bias. This contains a bias quantification engine configured to quantify levels of bias across both single columns and combinations of multiple columns in the data. This includes an encoding engine to quantify levels of information encoding across both single columns and combinations of multiple columns with respect to the specified bias target field. This includes a scoring engine to produce row-level, column-level, and/or dataset-level bias scores and calculates the magnitude and direction of mitigations to be applied to the dataset to mitigated any detected biases. This includes a mitigation engine that iteratively mitigates detected biases within the dataset until a specified level of bias is achieved.

### FIELD OF INVENTION

The present invention is related to bias in machine learning data, and more particularly, to a system and method for detection and mitigation of bias in data used for the training and evaluation of machine learning and AI systems.

### BACKGROUND

There is no doubt that the increased uptake by organizations of artificial intelligence (AI) is putting into sharp focus the question of the extent to which human biases have made their way into AI systems. Regulators around the world are also keenly aware that AI systems can produce biased results that reflect and perpetuate human biases within society, including historical and current social inequality. For this reason, we are seeing an increase in the adoption of laws and regulations creating obligations for organizations when it comes to detecting and mitigating AI bias. The EU AI Act represents the world's first comprehensive set of regulations aimed at governing artificial intelligence, and it is likely that similar regulations will follow in other jurisdictions around the world, making detecting and managing bias an important compliance requirement for AI.

The presence of bias in datasets is coming under more and more scrutiny in the modern world. Bias in data can be the result of many factors, including accurate reflections on current or historical biases or even a tainted collection or generation process, and it can be very difficult to determine whether such bias is present. If biased datasets are unwittingly used in real world systems or scenarios, the bias could lead to unwanted outcomes with potentially undesirable ramifications.

In particular, bias in datasets becomes especially important when a dataset is being used as the training input for a machine learning model or some other artificial intelligence (AI) systems. Any bias present in the data could be encapsulated within the model leading to the biases manifesting in the output predictions. Given the trend in the regulatory landscape for such models to be capable of explaining their decisions, it's vitally important that no outputs can be found to have been the result of an inherent bias within the model.

As such, organizations have an increasing need to detect the presence of any possible bias within the data, to measure the severity of impact of that potential bias on individuals, and demonstrate that they have taken steps to mitigate the effects of these biases. These impending requirements pose many challenges to organizations, including the need to acquire expertise in the areas of statistics, mathematics, machine learning, and bias & fairness. The system and method described herein aims to remove these obstacles by providing an all-encapsulating system for detecting, measuring, and mitigating bias within datasets, all without the need for deep expertise in the fields mentioned above.

Bias is typically measured at a full dataset level using a variety of statistical techniques and machine learning inferences. Classic examples of fields that might indicate the presence of bias are socio/economic/demographic fields such as age, gender, religious affiliation, race/ethnicity, country of origin, etc. Such fields are sometimes referred to as “bias prone” fields, or “bias targets”, and can be used to measure for the impacts and effects of any possible bias within the data. But even measurement of bias poses significant challenges.

The first issue is that any particular bias doesn't just sit cleanly within a single column in the data. As a simple example let's say we have some demographic data with a gender column. Removing this column doesn't make any gender effects disappear; each data point will still relate to a specific gender whether that gender column is excluded or not. Crucially, the signal of that gender may still be obtained from other fields via an effect known as encoding. For example, if heights or medical diagnoses were included in the dataset then these could allow inferences to be made about the gender, i.e. information about gender may be encoded in the “height” field. The encoding effect not only happens across individual columns, but crucially and more frequently happens across combinations of multiple columns. Furthermore, this encoding effect is not always easy or intuitive to detect. The correlation between height and gender is well known but the encoding could be more subtle. Take the example of a credit risk model which uses the number of dependents an individual has as a predictive feature when making its decision. Due to cultural norms men may be less likely to disclose the number of dependents they have, thus leading to this field becoming a proxy for gender and leading to a biased decision. Where strong encodings manifest for different groups within a dataset, the columns or combinations of columns that exhibit these strong encodings are known as bias proxies.

Even if we know where to look, simply measuring the effects of bias is not so straightforward. The next point is that bias generally manifests in some form of outcome or decision. This outcome/decision can be determined by humans, processes, or by automated machine learning and AI systems. Outcomes are typically the subject of scrutiny for bias or fairness, and as such are the fields in datasets that are measured for the presence of bias with respect to bias-prone fields such as age, gender, race/ethnicity, religious affiliation, etc. Consider a HR style dataset. Outcomes/decisions in such a dataset that could be impacted by bias could be salary ranges, performance ratings, whether or not an individual was hired or promoted, etc. Outcomes in the financial sector could be whether or not an individual was granted a loan application or mortgage, whether or not a payment was flagged as fraudulent, etc. Outcomes in the law enforcement sector could be whether an individual was arrested or not, whether one area is more heavily policed over another, etc. In the field of Machine Learning and Artificial Intelligence, the outcome or decision is typically the target variable/predictor of the machine learning system itself.

Once an outcome has been identified to be measured for levels of bias with respect to some bias prone fields/bias targets, a common starting point is to use some form of statistical measure. However, these are many and varied leading to a need for deep expertise before you can understand what to test and then how to interpret it. In particular these measures typically have different output ranges—for example KL—divergence is unbounded whereas Conditional Demographic Disparity ranges between −1 and 1. This difference in scale makes it difficult to come up with a consistent interpretation of what should be considered high, medium or low bias.

The next issue is that in-depth manual configuration underpinned by a deep understanding of the underlying statistical, mathematical, and machine learning processes is required to correctly design and configure each individual step of the bias measurement process, including specifying the columns against which to detect bias, and the columns which are to be measured for bias, defining the metrics and techniques to use for measuring bias, designing experiments, etc. A similarly high level of background knowledge and understanding in the areas of statistics, mathematics, and machine learning is required to correctly interpret and analyze the results. For example, certain known products simply provide a set of statistical measures for their bias detection module, leaving it up to the end user to determine the appropriate metric to measure the bias and to interpret the outcomes.

Finally, possibly the biggest challenges lie in the mitigation of any identified biases within data. A naive assumption is that the removal of bias-prone fields such as age, gender, race/ethnicity, religious affiliation, etc. will remove the bias from the data. However, like the myth of an ostrich burying its head in the sand when danger is close, the problem still exists even if it can't be seen—thanks to the encoding of the bias in proxies. In fact, removing those bias prone indicator fields can in most cases exacerbate the issue, as it makes it more difficult to easily observe or measure the levels of bias within the dataset. The issue with bias is more so to do with the individual data points or samples themselves. For example, consider a theoretical HR dataset with name, salary, job title, and gender information. A classic bias example is to measure such a dataset via statistical analysis for levels of gender/pay imbalance. However, if one were to ignore the gender field, the pay imbalance would still be present.

Bias is typically mitigated via techniques such as down-sampling or up-sampling of the dataset. Existing technologies for performing up-sampling include duplicating existing rows, generating synthetic data, or using packages such as SMOTE from Python's Sci-Kit Learn package. However, manual configuration is required in the up-sampling process and such systems require a substantial amount of background knowledge and training.

The problems with existing technologies can be summarized as the existing solutions are multiple fragmented solutions, all of which require a high degree of background knowledge and expertise in technical fields such as statistics, mathematics, and machine learning to configure, use, and interpret. This poses a significant barrier to smaller organizations who may not have the necessary expertise, yet who still need to address the issue.

The closest known technologies are not capable of automatically detecting bias target fields within a dataset, scanning a dataset for combinations of columns that most contribute to high bias within a dataset, automatically quantifying, and subsequently mitigating, any bias detected within a dataset.

For scanning and quantifying, such solutions do not currently exist on the market. These problems are currently performed via manual experiment design, manual configuration, and in-depth technical analysis. For example, in order to perform a bias analysis on a dataset, current techniques require the analyst to design a set of experiments to measure bias, define which field is the bias target field, manually filter and partition the data for each bias target, perform feature generation and data processing/cleansing steps on the data, run statistical tests and machine learning experiments, and analyze and interpret the results to draw conclusions.

Similarly, for mitigating bias in a dataset, not only are the scanning and quantifying steps required for initial detection of bias, but then similar subsequent labor-intensive solutions are required to design, configure, and execute a system to mitigate bias within a dataset.

In addition, no known solution exists for intelligently identifying sub-combinations of columns within a dataset that exhibit the highest instances of bias. This means existing solutions are only capable of measuring bias at the individual column level or at a full dataset level.

### SUMMARY

A system and method that allows for automated identification of bias prone fields (hereafter referred to as “bias targets”), bias detection and quantification in decision or outcome fields, bias encoding and bias proxy quantification, and optimised mitigation of datasets with minimal impact on utility is described. The system can operate fully autonomously or via manual configuration. The system and method at its most fundamental form takes as input a dataset and a configuration object and returns a report object and a mitigated version of that dataset, if the system so determines that such mitigation is required.

The system and method provide an automated sensitive field detection engine to automatically identify columns within a dataset that might indicate the presence of individuals or groups of people that are prone to discriminatory bias, the bias targets; a data modelling engine for generating a statistical, logical, and/or mathematical representation of the dataset; a bias quantification engine to quantify levels of bias within decision or outcome columns; an encoding quantification engine to quantify levels of encoded bias embedded within bias proxies hidden within the dataset; a scoring engine to aggregate bias and encoding levels at row, column, and dataset level, and to produce a scoring object; and an optimised bias mitigation engine to surgically and precisely mitigate the bias in the dataset at a row, column, or even an individual cell level, while continually measuring levels of utility across the dataset to ensure that any reduction in utility from the original dataset as a result of the bias mitigation engine is minimised. The system and method can be operated both manually and in a fully end-to-end autonomous mode, requiring no human in the loop.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a system diagram of an example of a computing environment in communication with a network;

FIG. 2 is a block diagram of an example device in which one or more features of the disclosure can be implemented;

FIG. 3 illustrates a method for automatic detection and mitigation of bias in data;

FIG. 4 illustrates a diagram of a system for bias quantification and mitigation according to the method of FIG. 3;

FIG. 5 illustrates a method performed by the sensitive field detection engine of FIG. 4;

FIG. 6 illustrates a method performed by the data modelling engine of FIG. 4;

FIG. 7 illustrates a method performed by the bias quantification engine of FIG. 4;

FIG. 8 illustrates a method performed by the encoding quantification engine of FIG. 4;

FIG. 9 illustrates a method performed by the scoring engine of FIG. 4;

FIG. 10 illustrates a method performed by the bias mitigation engine of FIG. 4; and

FIG. 11 illustrates a method for automatic detection and mitigation of bias in data.

### DETAILED DESCRIPTION

Given an input dataset(s) and a configuration object(s), the system and method employs a sensitive field detection engine to automatically, or via explicit configuration, scan the dataset for columns containing groups which may be the subject of potential bias within the dataset. These are not columns which that will be measured for bias, but rather these are columns which indicate whether bias may be present elsewhere in the data. These columns are either labelled automatically by the system, or manually by the operator via configuration as “bias target” columns. That is, these columns are the targets which define the groups of individuals against which the system is to measure the rest of the data for bias. Bias target columns scanning operates, for example, using how bias is typically described within a dataset. One would typically say: “this data is biased towards [the bias target column].” For example, “this data is biased towards people of African heritage”—the bias targets being race/ethnicity, and “this data is biased towards young men”—the bias targets here being the combination of age and gender.

Once bias target columns have been identified in the dataset, either by the automated sensitive field detection engine, or manually via user configuration, the system and method operates to scan one or more configured decision/outcome columns in the dataset for sources and levels of bias, measured against the previously identified bias target columns and combinations of bias target columns. In general, bias manifests in some form of outcome or decision that is considered unfair for certain sub-groups or demographics when compared with others. This outcome/decision may be determined by humans, processes, or by automated machine learning and AI systems. In an embodiment, the outcome or decision column may include describe salary ranges, performance reviews, or whether or not an individual was hired or promoted, etc. In an embodiment the outcome or decision column may be a machine learning target or predictor variable for whether or not an individual is approved for a loan application or mortgage.

The system and method operate to produce an output report that describes the automatically or manually identified bias target(s), the sources and levels of bias detected in the outcome or decision column(s), and the levels of bias and information encoding quantified between the identified or configured bias target(s) and the rest of the data itself.

If so configured, and if the detected bias levels are above a configured threshold, then the system performs mitigation of the identified bias in the dataset by at least one of down-sampling or removing rows which contribute to high bias, changing values that contribute to high bias, and/or up-sampling or synthesizing additional rows with features and values necessary to reduce the levels of detected bias to below a configured threshold value. Mitigation can be triggered manually via direct configuration, or the system can be configured to determine autonomously whether mitigation is required based on configured threshold values. Mitigation is performed in an optimized manner, which aims to balance minimal loss in configurable utility metrics against the reduction in bias levels.

The system and method may operate to scan the mitigated data again to fully re-evaluate the mitigated dataset to validate that the levels of bias have been sufficiently reduced below the configured thresholds. If the levels of bias have been sufficiently reduced below the configured thresholds, then the system outputs the mitigated data, along with a mitigation report object detailing the mitigation actions taken.

The system and method overcomes known issues by introducing an automated sensitive field detection engine to automatically identify columns within a dataset that might indicate the presence of bias within that data, a mathematically-based metric for the mathematical quantification of bias within a dataset, a multi-dimensional bias detection sub-engine for intelligently identifying combinations of columns that contribute to high bias within a dataset, and a bias mitigation engine to surgically and precisely mitigate the bias in the dataset at an individual cell level based on the results of the bias detection engine, thereby ensuring that any reduction in utility from the original dataset as a result of the bias mitigation engine is minimized. The system and method includes end-to-end automation that requires minimal configuration and no background knowledge or expertise in technical fields to operate.

The system and method operate to minimize bias as a result of the bias quantification metric, while simultaneously supporting a range of options for maintaining utility within the dataset by mitigating bias in a number of different manners, and provide end-to-end automation that requires no technical knowledge or expertise to run or configure.

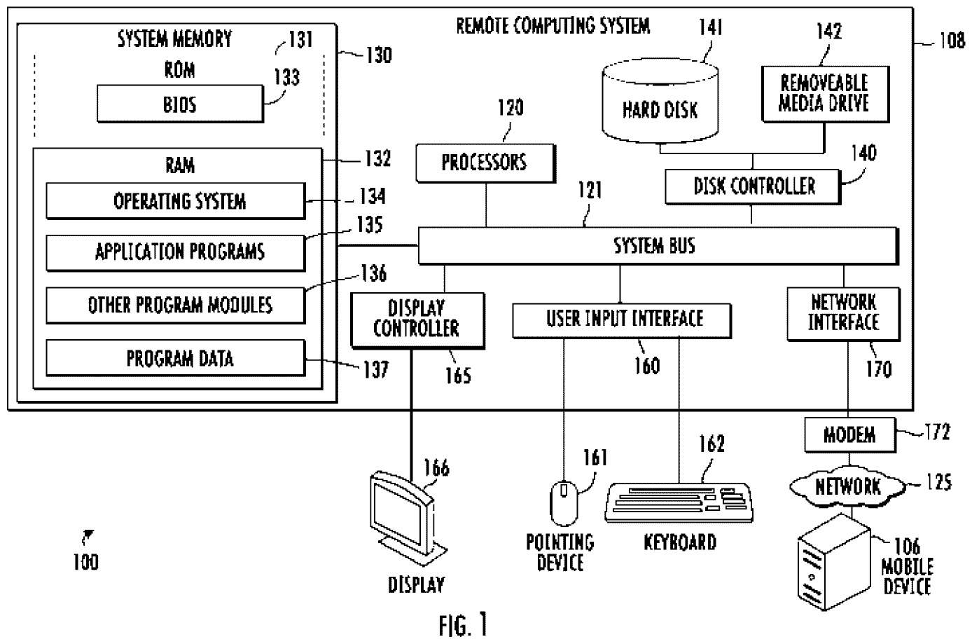

FIG. 1 is a system diagram of an example of a computing environment 100 in communication with a network. In some instances, the computing environment 100 is incorporated in a public cloud computing platform (such as Amazon Web Services or Microsoft Azure), a hybrid cloud computing platform (such as HP Enterprise OneSphere) or a private cloud computing platform. As shown in FIG. 1, computing environment 100 includes a remote computing system 108 (hereinafter computer system), which is one example of a computing system upon which embodiments described herein may be implemented.

The remote computing system 108 may, via processors 120, which may include one or more processors, perform various functions. The functions may be broadly described as those governed by machine learning techniques. Generally, any problems that can be solved within a computer system. As described in more detail below, the remote computing system 108 may be used to provide (e.g., via display 266) users with a dashboard of information, such that such information may enable users to identify and prioritize models and data as being more critical to the solution than others.

As shown in FIG. 1, the computer system 110 may include a communication mechanism such as a bus 121 or other communication mechanism for communicating information within the computer system 110. The computer system 110 further includes one or more processors 120 coupled with the bus 121 for processing the information. The processors 120 may include one or more CPUs, GPUs, or any other processor known in the art.

The computer system 110 includes a system memory 130 coupled to the bus 121 for storing information and instructions to be executed by processors 120. The system memory 130 may include computer readable storage media in the form of volatile and/or nonvolatile memory, such as read-only system memory (ROM) 131 and/or random-access memory (RAM) 132. System memory 130 may contain and store the knowledge within the system. The system memory RAM 132 may include other dynamic storage device(s) (e.g., dynamic RAM, static RAM, and synchronous DRAM). The system memory ROM 131 may include other static storage device(s) (e.g., programmable ROM, erasable PROM, and electrically erasable PROM). In addition, the system memory 130 may be used for storing temporary variables or other intermediate information during the execution of instructions by the processors 120. A basic input/output system 133 (BIOS) may contain routines to transfer information between elements within computer system 110, such as during start-up, that may be stored in system memory ROM 131. RAM 132 may comprise data and/or program modules that are immediately accessible to and/or presently being operated on by the processors 120. System memory 130 may additionally include, for example, operating system 134, application programs 135, other program modules 136 and program data 137.

The illustrated computer system 110 also includes a disk controller 140 coupled to the bus 121 to control one or more storage devices for storing information and instructions, such as a magnetic hard disk 141 and a removable media drive 142 (e.g., floppy disk drive, compact disc drive, tape drive, and/or solid-state drive). The storage devices may be added to the computer system 110 using an appropriate device interface (e.g., a small computer system interface (SCSI), integrated device electronics (IDE), Universal Serial Bus (USB), or FireWire).

The computer system 110 may also include a display controller 165 coupled to the bus 121 to control a monitor or display 166, such as a cathode ray tube (CRT) or liquid crystal display (LCD), for displaying information to a computer user. The illustrated computer system 110 includes a user input interface 160 and one or more input devices, such as a keyboard 162 and a pointing device 161, for interacting with a computer user and providing information to the processor 120. The pointing device 161, for example, maybe a mouse, a trackball, or a pointing stick for communicating direction information and command selections to the processor 120 and for controlling cursor movement on the display 166. The display 166 may provide a touch screen interface that may allow inputs to supplement or replace the communication of direction information and command selections by the pointing device 161 and/or keyboard 162.

The computer system 110 may perform a portion or each of the functions and methods described herein in response to the processors 120 executing one or more sequences of one or more instructions contained in a memory, such as the system memory 130. These instructions may include the flows of the machine learning process(es) as will be described in more detail below. Such instructions may be read into the system memory 130 from another computer readable medium, such as a hard disk 141 or a removable media drive 142. The hard disk 141 may contain one or more data stores and data files used by embodiments described herein. Data store contents and data files may be encrypted to improve security. The processors 120 may also be employed in a multi-processing arrangement to execute one or more sequences of instructions contained in system memory 130. In alternative embodiments, hard-wired circuitry may be used in place of or in combination with software instructions. Thus, embodiments are not limited to any specific combination of hardware circuitry and software.

As stated above, the computer system 110 may include at least one computer readable medium or memory for holding instructions programmed according to embodiments described herein and for containing data structures, tables, records, or other data described herein. The term computer readable medium as used herein refers to any non-transitory, tangible medium that participates in providing instructions to the processor 120 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 141 or removable media drive 142. Non-limiting examples of volatile media include dynamic memory, such as system memory 130. Non-limiting examples of transmission media include coaxial cables, copper wire, and fiber optics, including the wires that make up the bus 121. Transmission media may also take the form of acoustic or light waves, such as those generated during radio-wave and infrared data communications.

The computing environment 100 may further include the computer system 110 operating in a networked environment using logical connections to local computing device 106 and one or more other devices, such as a personal computer (laptop or desktop), mobile devices (e.g., patient mobile devices), a server, a router, a network PC, a peer device or other common network node, and typically includes many or all of the elements described above relative to computer system 110. When used in a networking environment, computer system 110 may include modem 172 for establishing communications over a network, such as the Internet. Modem 172 may be connected to system bus 121 via network interface 170, or via another appropriate mechanism.

Network 125, as shown in FIG. 1, may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 110 and other computers (e.g., local computing device 106).

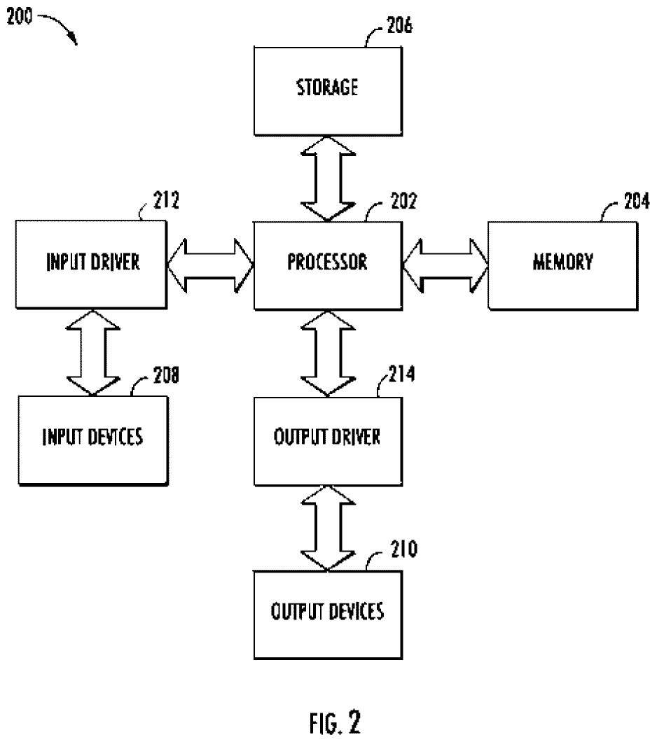

FIG. 2 is a block diagram of an example device 200 in which one or more features of the disclosure can be implemented. The device 200 may be local computing device 106, for example. The device 200 can include, for example, a computer, a gaming device, a handheld device, a set-top box, a television, a mobile phone, or a tablet computer. The device 200 includes a processor 202, a memory 204, a storage device 206, one or more input devices 208, and one or more output devices 210. The device 200 can also optionally include an input driver 212 and an output driver 214. It is understood that the device 200 can include additional components not shown in FIG. 2 including an artificial intelligence accelerator.

In various alternatives, the processor 202 includes a central processing unit (CPU), a graphics processing unit (GPU), a CPU and GPU located on the same die, or one or more processor cores, wherein each processor core can be a CPU or a GPU. In various alternatives, the memory 204 is located on the same die as the processor 202 or is located separately from the processor 202. The memory 204 includes a volatile or non-volatile memory, for example, random access memory (RAM), dynamic RAM, or a cache.

The storage device 206 includes a fixed or removable storage means, for example, a hard disk drive, a solid-state drive, an optical disk, or a flash drive. The input devices 208 include, without limitation, a keyboard, a keypad, a touch screen, a touchpad, a detector, a microphone, an accelerometer, a gyroscope, a biometric scanner, or a network connection (e.g., a wireless local area network card for transmission and/or reception of wireless IEEE 802 signals). The output devices 210 include, without limitation, a display, a speaker, a printer, a haptic feedback device, one or more lights, an antenna, or a network connection (e.g., a wireless local area network card for transmission and/or reception of wireless IEEE 802 signals).

The input driver 212 communicates with the processor 202 and the input devices 208, and permits the processor 202 to receive input from the input devices 208. The output driver 214 communicates with the processor 202 and the output devices 210, and permits the processor 202 to send output to the output devices 210. It is noted that the input driver 212 and the output driver 214 are optional components, and that the device 200 will operate in the same manner if the input driver 212 and the output driver 214 are not present.

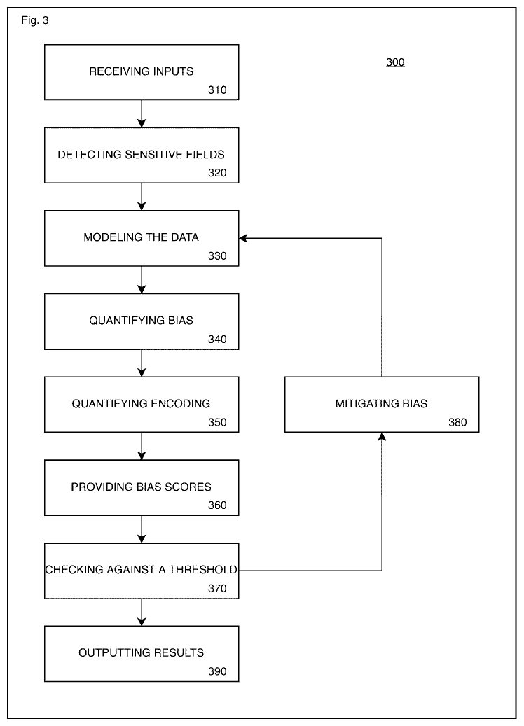

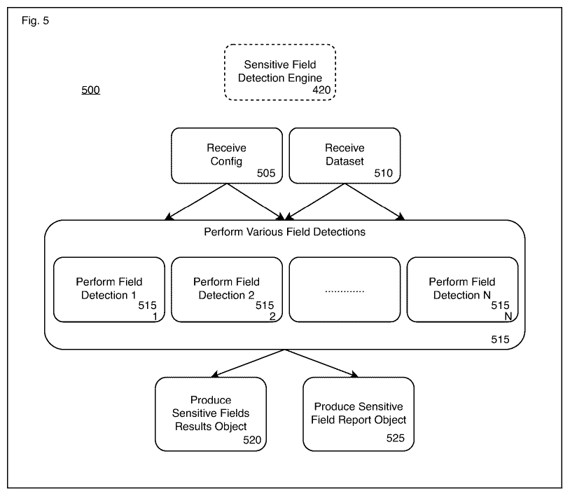

FIG. 3 illustrates a method 300 for automatic detection and mitigation of bias in data. Method 300 includes receiving inputs 310 including a dataset(s) and a configuration object(s). Method 300 includes detecting sensitive fields 320 by detecting sensitive data, either in a fully automated manner or via direct configuration as will be described in greater detail with respect to FIG. 5.

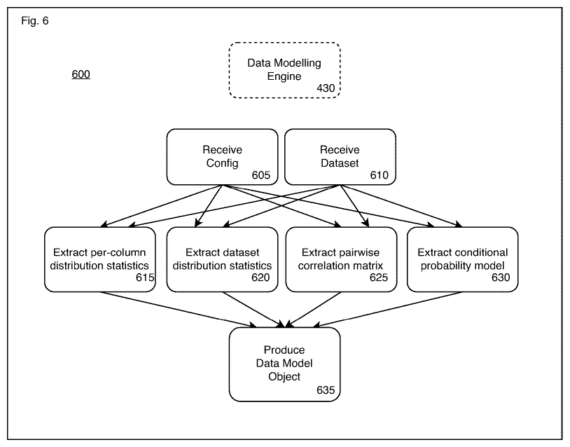

Method 300 includes modeling data 330 by generating a model of the received input, such as the dataset including, but not limited to, a description of the distributions and statistics of the various columns within the dataset, a description of the pairwise correlations measured between the combinations of columns, a description of the conditional probabilities for values and columns in the data, and/or a description of the logical structure within the data. This modeling data 300 is described in greater detail with respect to FIG. 6.

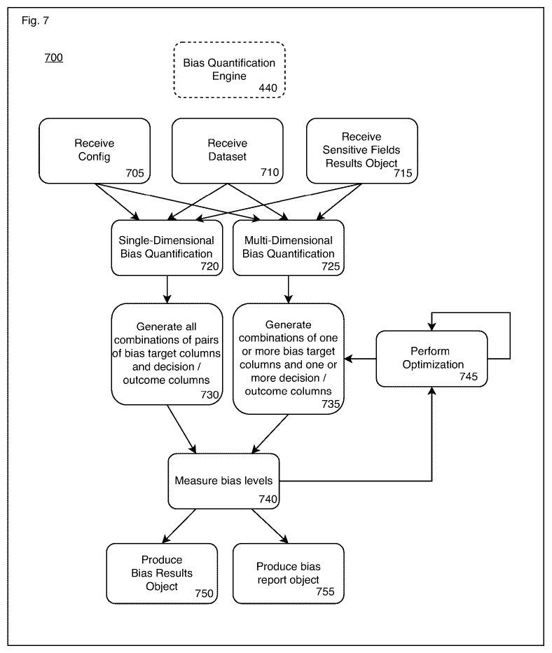

Method 300 includes quantifying bias 340 by performing one or more statistical tests or mathematical evaluations on the dataset to determine if there are differences in the distribution of a decision or outcome column or combination of decision or outcome columns X, and relative to a bias target column or combination of bias target columns Y. This quantifying bias 340 is described in greater detail with respect to FIG. 7.

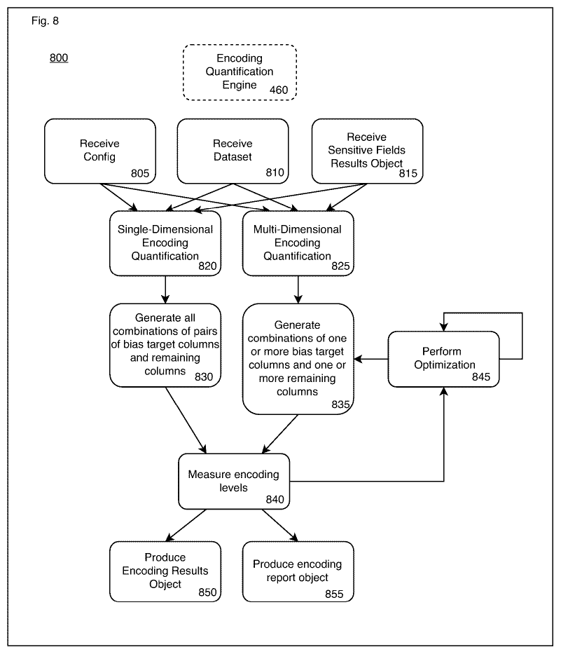

Method 300 includes quantifying encoding 350 by performing one or more mathematical evaluations on the dataset to determine the levels of information encoding or embedding between bias target column(s) Y and individual columns or combinations of columns from elsewhere within the dataset. This quantifying encoding 350 is described in greater detail with respect to FIG. 8.

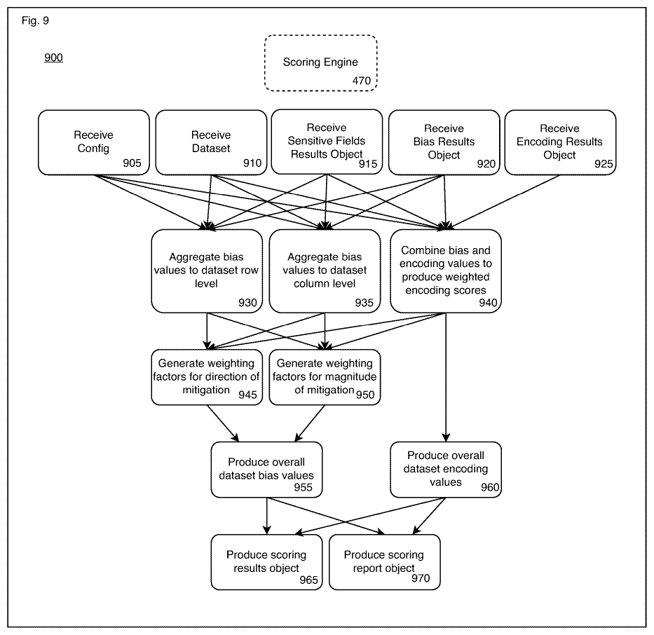

Method 300 includes providing bias scores 360 by generating a scoring results object from the detected sensitive fields 320, the quantified levels of bias 340, the quantified levels of encoding 350, and/or the modeled data 330. This providing bias scores 360 is described in greater detail with respect to FIG. 9.

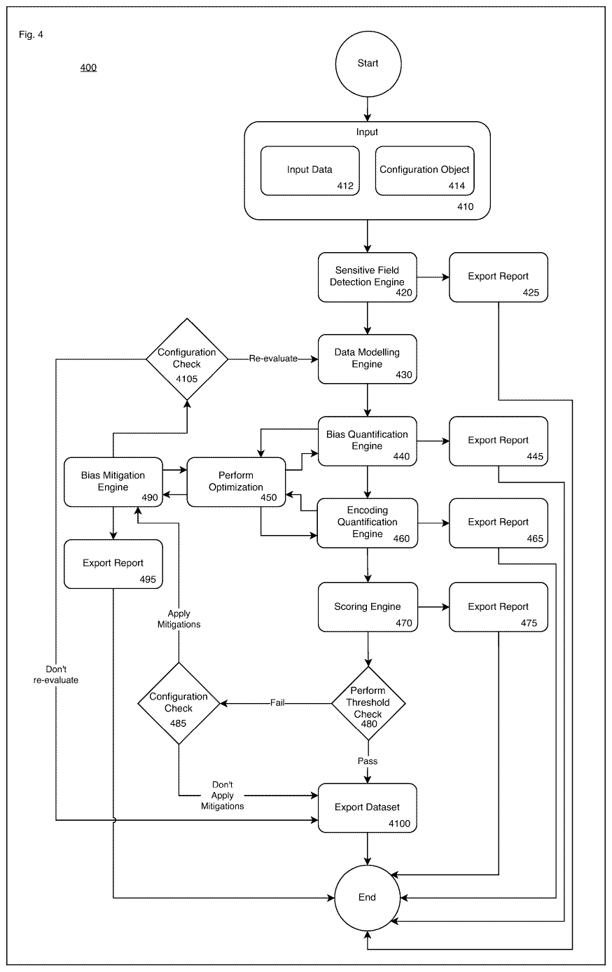

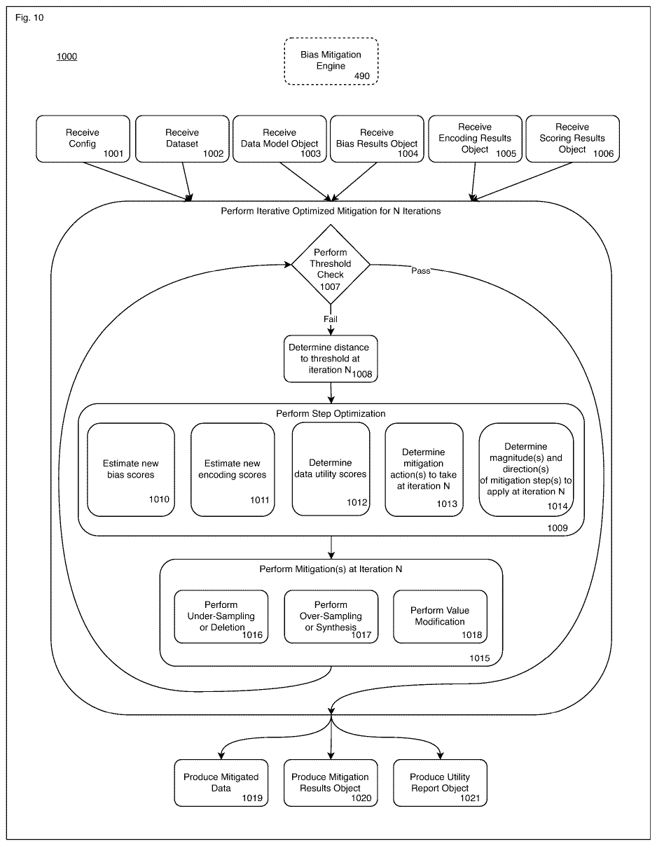

Method 300 includes checking the calculated bias against a threshold 370 and determining if mitigation is necessary. If mitigation is determined to be necessary, method 300 includes mitigating bias 380 (also there is a configuration check 485 of FIG. 4 described below) by at least one of iteratively down-sampling or removing rows from the dataset, modifying values within high bias rows or columns which are contributing the most to the overall bias within that row or column, and up-sampling or successively adding new synthetic rows of data to dataset. If so configured, the system mat recursively, re-evaluate the data from step 330 onwards. This iterative approach may account for the mitigation of bias in the data introducing new biases. This mitigating bias 380 is described in greater detail with respect to FIG. 10. Method 300 includes outputting the results 390.

FIG. 4 illustrates a diagram of a system 400 for bias detection and mitigation according to the method of FIG. 3. System 400 may operate within the computing environment of FIG. 1 in communication with a network and on, or in conjunction with, a device of FIG. 2. System 400 operates to detect and mitigate bias in a dataset. System 400 takes as input a dataset 412 and a configuration object 414, and outputs a dataset 4100 along with a number of report objects: 425, 445, 465, 475, 495. System 400 includes a sensitive field detection engine 420, a data modelling engine 430, bias quantification engine 440, encoding quantification engine 460, a scoring engine 470, and a bias mitigation engine 490 communicatively coupled as described below. Each of the engines may be configured with a processor and memory coupled to perform the function assigned to the engine. Each engine may operate across a single processor or utilize multiple processors for operation, in addition each engine may operate with a single or multiple memory units. Further, multiple of the engines may operate on a single processor and in conjunction with a memory or memories associated with that processor. As would be understood, all of the engines described may operate within a computer system using a single processing device and associated memory device or devices, or operating using multiprocessing technology.

System 400 includes a sensitive field detection engine 420 (described in further detail in FIG. 5). Sensitive field detection engine 420 may analyze and scan input data 412 for columns that indicate the presence of individuals or groups of people that are prone to discriminatory bias (hereafter referred to as “bias targets”). Sensitive field detection engine 420 produces a sensitive fields results object described in detail in FIG. 5 along with a summary report object. The sensitive fields results object describes the contents and nature of different columns within the data that may indicate the presence of bias or discrimination elsewhere within the data.

System 400 includes a data modeling engine 430 (described in further detail in FIG. 6). Data modeling engine 430 may generates a statistical, logical, and/or mathematical representation of the dataset included in input data 412 and a summary report object. The representation may be used by the bias mitigation engine 490 to determine the optimal means for mitigating bias within the data.

System 400 includes a bias quantification engine 440 (described in further detail in FIG. 7). Bias quantification engine 440 may quantify levels of bias, discrimination, or overall fairness in the dataset that may exist within decision or outcome columns relative to configured or automatically identified (such as by sensitive field detection engine 420, for example) bias target columns. Bias quantification engine 440 may produce a bias results object and a summary report object. The bias results object may be used by scoring engine 470 and bias mitigation engine 490.

System 400 includes an encoding quantification engine 460 (described in further detail in FIG. 8). Encoding quantification engine 460 may quantify how much information about the configured or automatically identified bias target columns is encoded or embedded within other columns across the dataset. High levels of information encoding may indicate that even if bias target columns are modified or even excluded from the dataset, their original form may potentially be re-created due to the presence of columns or combinations of columns that encode high levels of information about them, known as “bias proxies.” The presence of bias proxies, and their encoding strength, may indicate that biases experienced by groups described by the bias target fields may be propagated by the bias proxies. Encoding quantification engine 460 may produce an encoding results object and a summary report object. The encoding results object may be used by scoring engine 470 and bias mitigation engine 490.

System 400 includes a scoring engine 470 (described in further detail in FIG. 9). Scoring engine 470 may produce a scoring results object that describes the overall levels of bias and encoding across the dataset at row, column, cell, and overall dataset levels. Scoring results object may compile weighting factors for the direction and magnitude of mitigation actions to be taken at cell, row, column, and overall dataset levels. These weighting factors may describe the range of mitigation actions that may be applied to each element of the data, and the weighting factors may be used by an iterative optimization process within bias mitigation engine 490 to determine the set of mitigation actions to take in order to reduce bias levels while minimizing the reduction in data utility.

The scoring results object produced by scoring engine 470 may be compared against a threshold value, such as from configuration object 414, in a threshold check 480 and configuration check 485. On a condition that the overall detected levels of bias within dataset 412 are above a configured threshold level from threshold check 480, and if system 400 is configured to mitigate the bias in the data, then the system proceeds to bias mitigation engine 490 for further processing. In one embodiment, a threshold value may be set at 50 out of 100. In such a case, a maximum bias score identified by scoring engine 470 that is above this value of 50, e.g. 67 out of 100, triggers threshold check 480. In such a case, if configuration check 485 were to indicate that mitigation was desired, then this results in system 400 passing the input dataset 412 to bias mitigation engine 490 for mitigation.

System 400 may include a bias mitigation engine 490 (described in further detail in FIG. 10). Bias mitigation engine 490 may receive the various results objects produced by the previous components of system 400, including the data model object produced by data modeling engine 430, the bias results object produced by bias quantification engine 440, the encoding results object produced by encoding quantification engine 460, and the scoring results object produced by scoring engine 470. bias mitigation engine 490, while operating in an iterative manner, to optimize the actions taken at each iteration. This optimization process may interact with bias quantification engine 440 and encoding quantification engine 460 to re-evaluate the bias in the data and encoding levels during the mitigation process. The optimization process may quantify levels of utility in the data, such as described by the given configuration object 414. With knowledge of the current levels of bias, encoding, and utility in the data at iteration N, the optimization process may select the mitigation actions at iteration N+1. At each iteration, the detected levels of bias may be compared against the configured threshold value. Once the detected levels of bias are reduced below the threshold value, then bias mitigation engine 490 may end and the mitigated version of the data may be out with summary report objects describing the actions undertaken as part of the mitigation process.

Once bias mitigation engine 490 has completed processing the given dataset, configuration check 4105 may determine if a re-evaluation of the data is required. If such a re-evaluation is needed, the data may be communicated to data modelling engine 430 to enable system 400 to recurse. If configuration check 4105 determines that re-evaluation of the data is not required, the data may be exported to the user as export dataset 4100 and system 400 ends. If full re-evaluation of the data is configured, the system may recurse until the threshold check 480 or the configuration check 485 terminate the iteration process.

Due to the nature in which bias mitigation engine 490 estimates the mitigated bias scores during the mitigation process, multiple iterations of bias mitigation may be required to successfully reduce the bias levels below the configured threshold levels. Threshold check 480 and configuration check 485 may be required as part of the recursive nature of system 400 since system 400 may move to an infinite loop. For example, system 400 may determine that one extra row of data be added at iteration N, but then at iteration N+1 may determine that one row of data be removed, and then the data re-added at step N+2, etc. As such, configuration check 485 may prevent infinite recursion of system 400 via multiple options, such as by configuring a limit on the number of recursions or iterations of system 400 or by configuring a time limit for overall runtime of the recursive process.

Once the overall bias scores from bias results object 448 and scoring results object 476 are determined to be below the configured threshold level, the mitigated data is exported 4100.

Once threshold check 480 is passed or in the situation where the configuration check 485 is determined to not apply mitigation, dataset 412 may be exported 4100. If mitigation engine 490 was not employed by system 400, either by failing configuration check 485 or by passing threshold check 480, export dataset 4100 may be provided as input dataset 412 (i.e., input dataset 412 is not modified by system 400). Alternatively, output dataset 4100 may be a modified version of input dataset 412 that has passed through one or more iterations of mitigation and re-evaluation. In addition to output dataset 4100, system 400 may output report objects, such as report object 425 generated from sensitive field detection engine 420, report object 445 generated from bias quantification engine 440, report object 465 generated by encoding quantification engine 460, report object 475 generated by scoring engine 470, and report object 495 generated by bias mitigation engine 490 (if bias mitigation engine 490 was engaged, as appropriate).

FIG. 5 illustrates a method 500 performed by sensitive field detection engine 420 of FIG. 4. Method 500 includes receiving the configuration file at 505. The configuration filed may be received by the system via input configuration file 414 of system 400. Method 500 includes receiving the dataset at 510. The dataset may be received by the system via input dataset 412 of system 400. At 515, method 500 performs sensitive field detection routines on the (or a configurable subset of) columns from the received dataset. Each of the plurality of field detection routines may be optimized to detect a particular type of sensitive data. As illustrated in FIG. 5, at 515 generically provides the performing of one or more field detection routines 515. The field detection routines 515 may include any number of specific field detection routines 515₁, 515₂, . . . , 515_{N}, collectively referred to as field detection routines 515. Based on the performed field detection routines, method 500 includes reporting a sensitive field results object at 520 and includes producing a sensitive field report object at 525.

As would be understood that many variations of field detection routines are possible based on the disclosure herein. By way of example, one field detection routine may be optimized to detect fields containing race or ethnicity while another field detection routine may be optimized to detect fields containing religious affiliation, another for gender identifiers, another for age related information, etc. Field detection routines may implement a variety of technologies including natural language processing, logic tests, or regular expressions to surface candidates for potential bias targets, for example. Any number of field detection routines may be configured to allow the user to define any number of customized routines and sub-routines for identifying any form of bias targets within datasets, such as race or ethnicity, age, demographic features, accessibility requirements, physical or mental health diagnoses, etc.

Once each column in the received dataset at 510 has been evaluated by the field detection routine 515, the columns of the dataset may be tagged with the type or combination of sensitive fields present in that column (if any such sensitive fields have been detected by the respective field detection routines).

In an example, no sensitive fields are detected within a column. Sensitive field detection engine 420 may generate one or more sensitive fields results object(s) at 520, which may be produced in the form of a report at 525 and subsequently exported as report 425 of FIG. 4.

FIG. 6 illustrates a method 600 performed by data modelling engine 430 of FIG. 4. Method 600 includes receiving the configuration file at 605. The configuration file may be received by the system via input configuration file 414. Method 600 includes receiving the dataset at 610. The dataset may be received by the system via input dataset 412. At 615, method 600 includes extracting logical, mathematical, and/or statistical distribution information from each column (or a configurable subset of columns) from the received dataset. At 620, method 600 includes extracting logical, mathematical, and/or statistical distribution information for the overall received dataset (or a configurable subset thereof).

At 625, method 600 includes extracting of a pairwise correlation matrix. A correlation matrix describes the strengths of the mathematical, statistical, or informational relationships between the combination of pairs of columns in the received dataset.

At 630, method 600 includes extracting a description of the conditional probabilities for values and columns in the data. As would be understood by those possessing an ordinary skill in the art, while these descriptions are described in exclusive fashion above, each of the descriptions may be combined with another, or multiple other descriptions.

FIG. 7 illustrates a method 700 performed by bias quantification engine 440 of FIG. 4. Method 700 includes receiving the configuration file at 705. The received configuration file may be received by the system via input configuration file 414. Method 700 includes receiving the dataset at 710. The received dataset may be received by the system via input dataset 412.

Method 700 includes receiving the sensitive field results object at 715 produced by the sensitive field detection engine 420. Bias within the dataset may be hidden in single individual columns or across combinations of multiple columns. The bias may be measured between “bias target” columns and “decision or outcome” columns. The decision or outcome columns X are obtained from the configuration object received at 705, while the bias target columns Y may be manually specified by the user via configuration object received at 705 and/or may be obtained from sensitive field results object received at 715.

Method 700 includes measuring bias at 740. The measured bias may be used for quantifying levels of bias between a given bias target column (or combination of bias target columns) and a decision or outcome column (or combination of decision or outcome columns). Bias measurement at 740 may include one or more statistical tests to determine if there are differences in the distribution of a column or combination of decision or outcome columns X, and a bias target column or combination of bias target columns Y. Bias measurement at 740 is designed to measure fairness—if the data is unbiased or fair then there should be no significant deviation in the probability distribution of X when subset over the different groups present in the target column(s) Y.

In one embodiment, the bias or fairness may be measured via the use of mathematical statistical distribution comparison techniques. Such techniques are employed in the fields of mathematics and statistics to determine whether two samples can be considered to be drawn from the same mathematical distribution. Examples of such comparison metrics can include Kolmogorov-Smirnov tests, chi-squared tests, Kullback-Leibler (KL) divergence, among others. By taking the distribution of the decision or outcome values as measured against the entire dataset as “ground truth” for a fair distribution of outcomes, the statistical distribution of each bias group Y may be compared against this “ground truth” distribution in order to measure differences in the distributions. Significant deviation between the “expected” distribution (i.e. the “ground truth” distribution as measured across the entire dataset) in comparison to the “actual” distribution for a given bias target group y may indicate that that group may experience a bias in the decision or outcome in question. The magnitude of the difference between the expected and actual distributions is a quantified measure of the level of bias experienced by the group.

In another embodiment, the bias or fairness may be measured using conditional entropy. Specifically, a bias quantification metric may evaluate for each group y within the bias target Y, the conditional entropy of X conditioned on each y. By comparing the divergence of the measured conditional entropy against the expected overall entropy of X, bias can be identified as significant deviations between these expected and measured values. Bias levels may be normalized between the range of 0-100 at 740, ensuring a standardized scale. This standardized scale can be readily interpreted by the user, allowing for the configuration of threshold values to define scores of interest. For example, in one embodiment the user may configure “high”, “medium”, or “low” bias values by setting the threshold values such that any bias score below 30 is classified as “low” bias, any score above a value of 70 is classified as “high” bias, and all other scores (i.e. those scores between the values of 30 and 70) are classified as “medium” bias.

The received dataset and configuration file are provided as inputs to single-dimensional bias quantification at 720 and multi-dimensional bias quantification at 725. Single-dimensional bias quantification split 720 includes generating all pairwise combinations of configured or automatically detected bias target columns and individual decision/outcome columns at 730. For each bias target column Y, either an optionally configurable subset of decision or outcome columns X, or the full set of all decision or outcome columns X are individually prepared for evaluation at 730. Method 700 includes evaluating bias levels at 740 across generated combinations of columns. At 750, method includes storing results in a bias results object and producing a report at 755.

For multi-dimensional bias quantification, method 700 includes generating multiple combinations of bias target columns and decision or outcome columns at 735. The generation and evaluation of multi-dimensional bias may be performed using an optimization at 745. The optimization may be performed to intelligently search through the potentially vast space of combinations of bias target columns and decision or outcome columns X to evaluate combinations of columns and values within the data which exhibit high overall bias values. High overall bias values may be measured using the bias quantification metric at 740. For datasets with a high number of decision or outcome columns, the number of combinations of these columns to explore grows exponentially. At some point, it becomes inefficient and/or infeasible to investigate every single column combination, and thus an optimization/search technique may be employed (e.g., hillclimber, genetic algorithm, gradient descent, simulated annealing, etc.). The technique may be performed for each bias target column Y and, in addition, for combinations of bias target columns, for example. Evaluated combinations may be sorted with respect to the combination resultant overall bias scores and may be stored in bias results object at 750 and may produce a report at 755.

FIG. 8 illustrates a method 800 performed by encoding quantification engine 460 of FIG. 4. Method 800 includes receiving the configuration file at 805. The received configuration file may be received by the system via input configuration file 414. Method 800 includes receiving the dataset at 810. The received dataset may be received by the system via input dataset 412. Method 800 includes receiving the sensitive field results object at 815 produced by the sensitive field detection engine at step 420. Information encoding within a dataset may be hidden in single individual columns or across combinations of multiple columns, and is measured between “bias target” columns and other columns from across the dataset. The columns X to be measured for encoding strength for each bias target column Y may be all remaining columns (outside of the bias target and decision/outcome columns), or they may be a configurable subset thereof, as dictated by the configuration object received at 805. The bias target column(s) Y may be manually specified by the user via configuration object received at 805 or may be obtained from sensitive field results object 815.

Method 800 includes performing an encoding measurement at 840. The encoding measurement mat be used to quantify levels of encoding between a given bias target column (or combination of bias target columns) and another column (or combination of columns) from elsewhere in the wider dataset. The purpose of quantifying information encoding levels is to quantify hidden levels of information and bias encoding hidden within the wider dataset. A popular but naive strategy for mitigating bias in data is simply to delete the bias target columns, e.g., in a dataset containing gender, race/ethnicity, or religious affiliation information, it is often thought that by removing those offending columns the bias disappears. However, in many cases enough information about these bias target columns is embedded or encoded within the rest of the dataset that even if the bias target columns are deleted, the effects of the bias target columns may be reconstructed using the rest of the data. The columns in which this information is encoded or embedded are referred to as “bias proxies,” as the columns may act as a proxy for the bias targets and propagate bias experienced by impacted sub-groups or demographics. This means that even if the bias target columns are removed, any biases present towards those bias target columns may remain in the data. This effect is explicitly what the encoding quantification engine quantifies.

Measuring encoding levels at 840 may include mathematical or statistical techniques to measure the shared information content between all bias target groups and sub-groups across the given bias target column or columns with respect to other data columns from across the wider dataset. Where high information content exists for a given bias target group or sub-group within another column or combination of columns found elsewhere in the data, this means that the given bias target group may be re-created, reconstructed, or re-identified using the information from that column or combination of columns. These columns or combination of columns are therefore known as “bias proxies.”

In an embodiment, encoding strength may be measured using conditional entropy, or mutual information. Where high conditional entropy/mutual information exists between two given columns A and B, it can be said that the information from column A can be inferred from the information given in column B. Thus, column B may act as a “proxy” for column A.

In an embodiment, encoding strength may be measured between two columns A and B by evaluating standard statistical correlation metrics between the two columns. For example, correlation strength between two columns containing continuous numerical data can be measured using Pearson or Spearman correlation. A high correlation value between column A and column B may mean that information from one column may be used to infer information from another, thus the columns act as proxies for one another.

An aspect of measuring encoding strength is that encoding is measured at a group level (i.e., across all groups and sub-groups identified by the bias target columns), rather than across the entire column. This is because while a particular group within a bias target field (e.g., older women with accessibility requirements) may have a particularly high encoding strength within the wider dataset (e.g., information on medical diagnosis may allow this group to be easily singled out). Other groups may have a low encoding strength due to less specificity across the rest of the data. If encoding were to be measured across the entire column (or combination of columns), the impact of groups may be averaged out, resulting in important encoding information being missed by the system. The net result of a system that fails to measure encoding strength at a group or sub-group level is that true bias or encoding measures could be higher than those numbers reported by such a system, leading to significant legal, operational, or personal risks.

The received dataset and configuration file are provided as inputs to single-dimensional encoding quantification at 820 and multi-dimensional encoding quantification at 825. For single-dimensional encoding quantification, method 800 includes generating pairwise combinations of configured or automatically detected bias target columns and individual other columns from across the wider dataset at 830. For each bias target Column Y, either an optionally configurable subset of other columns X, or the full set of other columns X are individually prepared for evaluation at 830. Method 800 proceeds by evaluating encoding levels at 840 across generated combinations of columns. The results may be stored in an encoding results object at 850 and may be produced in the form of a report at 855.

For the multi-dimensional encoding quantification, method 800 includes generating multiple combinations of bias target column(s) and other column(s) from across the wider dataset at 835. The generation and evaluation of multi-dimensional encoding at 835 may be performed using by optimizing at 845. The optimization may be performed to intelligently search through the potentially vast space of combinations of bias target columns and other columns X and evaluate combinations of columns and values within the data which exhibit high overall encoding levels. High overall encoding levels may be measured using the encoding quantification metric at 840. For datasets with a high number of columns, the number of combinations of these columns to explore grows exponentially. At some point, it becomes inefficient and/or infeasible to investigate every single column combination, and thus an optimization/search technique may be employed (e.g., hillclimber, genetic algorithm, gradient descent, simulated annealing, etc.). The technique may be performed for each bias target column Y and, for combinations of bias target columns, for example. Evaluated combinations may be sorted with respect to the combination resultant overall encoding levels and may be stored in an encoding results object at 850 and may be produced in the form of a report at 855.

Method 800 concludes by producing an encoding results object at 850. The encoding results object may include encoding results for individual bias target columns and combinations of (or a potentially optimized subset of combinations of) multiple bias target columns, as measured against both individual single columns and a potentially optimized subset of multiple combinations of columns from across the wider dataset. The encoding results object produced at 850 may be produced in the form of a report at 855.

FIG. 9 illustrates a method 900 performed by scoring engine 470 of FIG. 4. Method 900 includes receiving the configuration file at 905. The received configuration file received by the system may be input configuration file 414. Method 900 includes receiving the dataset at 910. The received dataset received by the system may be input dataset 412. Method 900 includes receiving the sensitive field results object at 915 produced by the sensitive field detection engine 420. Method 900 includes receiving the bias results object at 920 produced by the bias quantification engine 440. Method 900 includes receiving the encoding results object at 925 produced by the encoding quantification engine 460. Method 900 operates to combine the received inputs to calculate additional bias and encoding scores at cell, row, column, and overall dataset levels, and to generate weighting factors for the magnitude and direction of mitigations to be applied to the dataset. Method 900 may produce a scoring results object at 965, which may additionally be produced in the form of a report at 970.

Method 900 may assign scores to each row of the input dataset received at 910 based on the given inputs, and subsequently calculate overall aggregated scores for the entire dataset. Row, column, and dataset-level scores as contained in the scoring results object produced at 965 are used as input to bias mitigation engine 490, and are additionally presented to the user as additional bias scores in the form of a scoring report object at 970.

Method 900 may include the aggregation of bias values to row-level at 930. This aggregation of bias values to row-level includes as input the received configuration from step 905, received dataset from step 910, received sensitive results object from step 915, and received bias results object from step 920. From the inputs, method 900 may compute an aggregated bias contribution score for each row within the given dataset. In an embodiment, the aggregated bias contribution score can be taken as the maximum score for any cell within the row. In an embodiment, the aggregated bias contribution score can be taken as an average or weighted average value across values within a row. As would be understood, many different implementations of aggregating scores to a row level are possible. This aggregated bias contribution score may identify or correlate to the overall bias score as computed in step 955 for input dataset 910 as a result of each particular row. The aggregated bias contribution score may be stored for each row in a scoring results object at 965 and produced in the form of a report at 970.

Method 900 may include the aggregation of bias values to column level at 935. This aggregation of bias values to column level may receive the received configuration from step 905, received dataset from step 910, received sensitive results object from step 915, and received bias results object from step 920. From the inputs, method 900 may compute an aggregated bias contribution score for each column within the given dataset. In an embodiment, the aggregated bias contribution score can be taken as the maximum score for any cell within the column. In an embodiment, the aggregated bias contribution score can be taken as an average or weighted average value across values within a column. As would be understood, many different implementations of aggregating up scores to a column level are possible. This aggregated bias contribution score may identify or correlate to the overall bias score as computed in step 955 for input dataset 910 as a result of each particular column. The aggregated bias contribution score may be stored for each column in a scoring results object at 965 and also reported in a report at 970.

Method 900 may include the combination of bias values and encoding values to generate weighted encoding scores at 935. This combination of bias values and encoding values to generate weighted encoding scores receives as input the received configuration from step 905, received dataset from step 910, received sensitive results object from step 915, received bias results object from step 920, and received encoding results object from step 925. From the inputs, method 900 may compute a weighted encoding score for each element within the given dataset. The weighted encoding score may more accurately identify bias proxy columns for different groupings of bias targets. While certain groups or sub-groups from the bias target fields may have strong correlations or encodings across a dataset (for example, older individuals are more likely to have higher salaries; people of Dutch heritage are more likely to be tall), some correlations may reflect expected behaviors in the data; in essence, the case where high encoding but low bias exists is more often than not unremarkable. By combining the bias scores with the encoding scores to give weighting to the encoding scores, method 900 can for example identify where certain groups or sub-groups may have both high bias and high encoding at step 940. For example, where older females have disproportionately lower salaries compared to older males, combined with a strong correlation with older females and job title, or a strong correlation between older females and cumulative leave of absence (e.g., due to maternity leave). These groups are those may be at risk of bias propagation via bias proxies, and thus the system may address when it comes to mitigation. This aggregated bias contribution score may identify or correlate to the overall encoding score in step 960 for input dataset 910 as a result of each particular element. The weighted encoding scores may be stored for each element in a scoring results object at 965 and reported at 970.

In addition to calculating the aggregated bias score for each row in the received dataset, steps 945 and 950 of method 900 may also interpret the scores given by bias results object received in step 920 and encoding results object received in step 925 to calculate weighting factors for each row in the received dataset. Weighting factors may be indications of the direction (as calculated in step 945) and magnitude (as calculated in step 950) of mitigation actions to be taken for each row in the dataset. In an embodiment, directional factors for mitigation of rows may take the form of “up-sampling” (e.g., duplicating or replicating rows via some up-sampling or synthesis process in order to generate more samples with similar characteristics) or “down-sampling” (e.g., deleting or otherwise removing rows from the data). The magnitude of the effect may dictate a measure of the amount of action that may be undertaken (i.e., the magnitude of the effect) in order to achieve a fairer distribution for the configured decision or outcome column. For example, the number of rows may be either up-sampled or down-sampled, as appropriate. In an embodiment, since the global distribution of decision or outcome values as measured across the entire dataset is considered the baseline “fair” distribution, any deviation from that distribution for any bias target group or sub-group (i.e., an identified bias) may be rectified by combinations of up-sampling or down-sampling different rows as appropriate in order to achieve a distribution for the bias target group that is closer to that of the global distribution.

By way of example, given bias target columns of “age” and “gender” (as given in sensitive fields results object in step 915), a bias target group from these columns may be “females aged 60-90” and by example this group may experience a higher than normal bias for the outcome of “credit loan approval,” with the significant majority of applicants in this group having their application rejected while all other groups demonstrate a more balanced outcome of applications. The row scoring step 930, and direction and magnitude steps 945 and 950 may indicate that samples of negative credit loan approval for this bias target group may be down-sampled (since they are over-represented with respect to the global “fair” distribution), while samples of positive credit loan approval may be up-sampled (since they are under-represented with respect to the global “fair” distribution).

Method 900 includes the aggregation of bias scores to overall dataset level at 955 to produce additional bias scores. These aggregated scores may, for example, give an indication of the total number of rows to be up-sampled, the total number of rows to be down-sampled, and distribution or statistical measures on the weighting factors calculated by the row scoring sub-engine.

Method 900 includes the aggregation of encoding scores and weighted encoding scores to overall dataset level at 960 to produce additional encoding scores. These aggregated scores may for example provide an indication of the total number of groups experiencing each different level of weighted encoding, or the total number of columns that act as bias proxies to a high degree.

Overall dataset level bias scores produced at 955, and overall dataset level encoding scores produced at 960 are compiled into a scoring results object at 965 that exemplifies the overall levels of bias and encoding within the received dataset. The overall bias and encoding scores may additionally be reported as a report object at 970.

FIG. 10 illustrates a method 1000 performed by bias mitigation engine 490 of FIG. 4. Method 1000 includes receiving the configuration file at 1001. The received configuration file received by the system may be input configuration file 414. The received dataset received by the system may be input dataset 412 (or a modified version of dataset 412 which has already been mitigated by mitigation engine 490, for example). The data model object at 1003 produced by the system at 635 of method 600, the bias results object at 1004 produced by the system at 750 of method 700, the encoding results object at 1005 produced by the system at 850 of method 800, the scoring results object at 1006 produced by the system at 965 of method 900 may be provided to bias mitigation engine 490.

Method 1000 performs a threshold check at 1007. The received scoring results object from step 1006 is compared against the received configuration object from step 1001. If the threshold check at 1007 fails (for example, if the detected scores are above the configured threshold value), method 1000 may proceed with iterative optimized mitigation.

Method 1000 may determine the distance to the configured threshold at 1008. For example, if the configured threshold is set to 30 and the actual score from scoring results object received at 1006 is 55, the distance to the configured threshold may be the difference between those two values, i.e., a magnitude of 25. This distance is then used by the iterative optimization at 1009 to determine the mitigation actions to take at iteration N. The optimization performed at 1009 includes determining the mitigation action (or actions) to take at iteration N (at 1013), the magnitude or magnitudes of the actions to take at iteration N and the direction (at 1014). For example, if the optimization process at 1009 determines that a large change is needed at iteration N (for example, if the remaining distance to the threshold as calculated in 1008 is large), the optimization process may select multiple actions to be taken, with large magnitudes for each action in order to change the scores by a correspondingly large amount. If the optimization process at 1009 determines that a small change is needed at iteration N (for example, if the remaining distance to the threshold as calculated at 1008 is small, i.e., the current score is close to the threshold), then the optimization process may elect to only perform one small action in order to change the scores by a correspondingly small amount.

As part of optimization step 1009, the bias mitigation engine interfaces with bias quantification engine 440 to estimate the new bias scores for the dataset after the planned mitigation action that would be taken at iteration N. This estimation may be performed with the received bias results object from step 1004 and the received scoring results object from step 1006.

As part of optimization step 1009, the bias mitigation engine interfaces with encoding quantification engine 460 to estimate the new encoding scores for the dataset after the planned mitigation action that would be taken at iteration N. This is done in conjunction with the received encoding results object from step 1005 and the received

### Scoring Results Object From Step 1006.

As part of optimization step 1009, data utility scores are determined at 1012. Utility metrics may be defined by the received configuration object 1001, and may use received data model object 1003 and encoding results object 1005 to help provide additional utility context, and describe the means by which utility is to be measured within the dataset. In an embodiment, utility may be configured to be measured by examining the richness and quality of the data, in terms such as number of feature columns, number of rows, the granularity or cardinality of individual or specific columns, mathematical or statistical distribution metrics for specific or individual columns, average or specific pairwise correlation values, etc., as described in data model object 1003. In an embodiment specific to machine learning, utility may be configured to train an appropriate machine learning model over the dataset and evaluate its accuracy. As would be understood, many different implementations are possible for configuring utility metrics, as may be appropriate for the use case at hand.

Once the optimization process at 1009 has determined the mitigation actions to be taken at iteration N, method 1000 includes performing mitigation actions for iteration N at 1015. Mitigation actions may include any one or more of performing over-sampling or synthesis at 1016, performing under-sampling or deletion at 1017, and performing value modification at 1018. The various mitigation techniques may be employed to change the distributions of the dataset received at 1002 in order to reduce the levels of bias detected by the bias quantification engine 440 (as given in scoring results object at 1006).

Method 1000 includes the performing of under-sampling or deletion as a mitigation technique at 1016. Under-sampling or deletion may mitigate bias by selectively removing rows from dataset 1002, as indicated by scoring results object received at 1006. As described herein, each row in the data is scored in the scoring results object for the magnitude of change required in order to reduce the levels of bias below the configured threshold value. In the case where this magnitude indicates removal of a row, the under-sampling process at 1016 handles this request. Rows are selected for removal based on their ordered aggregated row level scores from scoring results object 1006, i.e. those rows with the highest scores and/or estimated reduction in bias may be removed first, for example. Rows are removed in an iterative fashion, which is controlled by the optimization process at 1009.

Method 1000 includes the performing of over-sampling or synthesis of new rows at 1017. The over-sampling or synthesis process may mitigate bias by up-sampling the received dataset from 1002 using techniques such as, but not limited to, statistical oversampling or synthesis. Bias may be mitigated by successively adding new rows of data to dataset 1002 in such a way that each new field x within the column X is selected based on bias results object 1004, scoring results object 1006, and the data model object 1003 to reduce the overall bias score for column X. In the case where the bias quantification metric is based on entropy, a new value x for column X can be selected using the conditional probability model from the data model object 1003 filtered on values which increase the partial conditional entropy. In the case where the bias quantification metric is based on statistical distribution metrics, a new value x for column X can be selected using the conditional probability model from the data model from data model object 1003 filtered on values which reduce the statistical distribution imbalance contributing to the identified bias levels. As with the value modification process at 1018, the logical and structural constraints described in the data model are used to replicate the overall statistical distributions of dataset 1002 within the newly generated portion of the mitigated dataset. The values in high bias rows or columns may be crafted in such a way as to maximize the reduction in bias for each column.

In an embodiment, the over-sampling or synthesis process at 1017 may employ classical oversampling techniques, such as SMOTE, to generate new rows of data. In an embodiment, the over-sampling or synthesis process may employ a range of synthesis processes such as Bayesian techniques, Generative Adversarial Networks (GANs), probabilistic models, or other techniques, for example, as would be understood by those possessing an ordinary skill in the art.

Method 1000 includes the performing of value modification at 1018. The value modification process may mitigate bias within the received dataset from 1002 by identifying values within rows or columns which are contributing the most to the overall bias within that row or column. As described herein, scoring results object 1006 (as generated from scoring engine 470 from system 400 and described in method 900) assigns magnitude and direction to each value in a row or column that indicates its contribution to overall bias levels. The value modification process then compares these magnitudes and directions against the magnitudes and directions of other values within the column. Where the data model object received at 1003 permits changes of values without substantially altering the utility of the data (as quantified by utility quantification at 1012), the value modification process may change values within a column or row to other values which may reduce the magnitude of the bias impact. Values are modified in an iterative fashion, as is controlled by the optimization process at 1009.

In an embodiment, the value modification process at 1018 may generalize or otherwise bin continuous and/or numeric values in order to reduce their granularity. Bin sizes and thresholds may be determined by the value modification process in conjunction with the optimization process at 1009 such that bias values are reduced by a measurable amount (as measured by bias quantification engine 440 via the estimation at 1010). The granularity and size of such generalization or binning steps may increase at each iteration of the optimization algorithm, for example, with each increase in bin size correspondingly decreasing the granularity of the data, which may act to reduce levels of bias but also reduce levels of utility. This is one example of the manner in which the optimization process at 1009 may strive to maintain a balance between the reduction in utility and the reduction in bias.

In an embodiment, the value modification process at 1018 may operate to replace a given value which corresponds to a high bias contribution (as quantified by scoring results object 1006) with another value which corresponds to a lower bias value. In such cases, the data model object received at 1003 may be utilized to ensure that the logical, mathematical, or statistical makeup of the dataset is not broken. For example, the data model may include a description of the conditional probability distributions for all columns and all values. It may, for example, permit the replacement of one value in a row with a different value, since the new value may be within the available logical choices for all other values within that row. By way of example, consider a dataset containing employment information. If one column were “team,” containing values such as “engineering,” “human resources,” “sales,” etc., while another column were “job title,” the data model produced by data modelling engine 430 and received at 1003 may compile a logical map of the data which collates all permissible values of “job title” for each given value of “team.” Such a logical map may prohibit combinations such as “team: human resources; job title: sales lead,” or “team: sales; job title: back-end engineer,” for example. However, such a logical map may permit the job title “back-end engineer” to be replaced with “front end engineer” if such a modification were to result in the reduction of the bias score.

By replacing values within the dataset without adding or removing any rows, the value modification process at 1018 may operate to make small changes to the dataset that may have small impacts on the changes in bias or utility. As such, the value modification process at 1018 may be employed when very small changes in gradient are required by the optimization process at 1009.

Once the mitigation process for iteration N has completed at 1015, the system recurses back to step 1007 for iteration N+1. If the threshold check at 1007 fails, the system may recurse as described above. However, once the threshold check at 1007 passes (for example, the bias scores as estimated by step 1010 has been reduced below the configured threshold), the iterative optimization process may conclude. Method 1000 may conclude when the mitigated data is provided at 1019, a report detailing mitigation activities taken at 1020 and a utility report object at 1021.

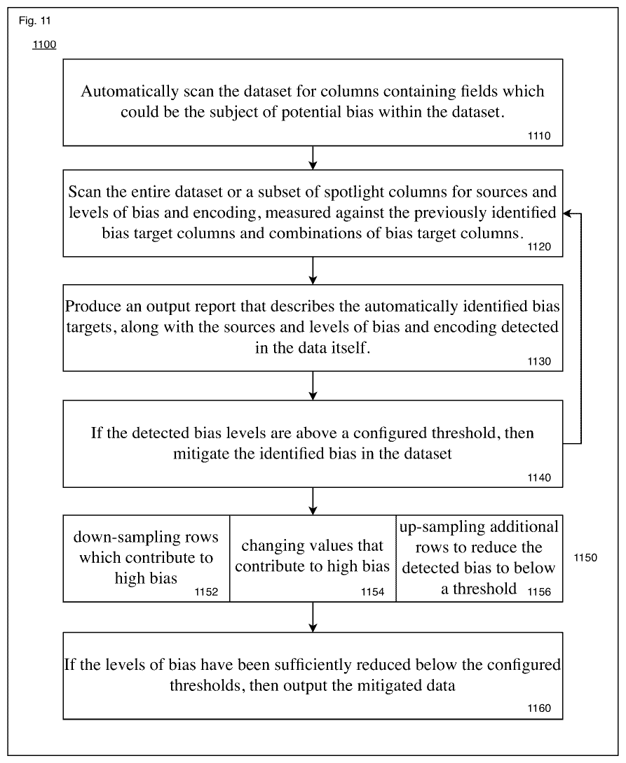

FIG. 11 illustrates a method 1100 for automatic detection and mitigation of bias in data. Method 1100 includes, at 1110, automatically scanning the dataset for columns containing fields which may be the subject of potential bias within the dataset. At 1120, method 1100 includes scanning the entire dataset or a subset of the spotlight columns for sources and levels of bias and encoding, measured against the previously identified bias target columns and combinations of bias target columns. At 1130, method 1100 includes producing an output report that describes the automatically identified bias targets, along with the sources and levels of bias and encoding detected in the data. At 1140, method 1100 includes determining if the detected bias levels are above a configured threshold, then if so, mitigating the identified bias in the dataset. At 1150, method 1100 includes employing various techniques to mitigate the bias. The techniques may include down-sampling or removing rows 1152 which contribute to high bias, changing values 1154 that contribute to high bias, and/or up-sampling or synthesizing additional rows 1156 to reduce the detected bias to below a threshold. If the levels of bias have been sufficiently reduced below the configured thresholds, or once reduced in the system, method 1100 includes at 1160 outputting the mitigated data.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read-only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement the present methods for use in other electronic hardware.

What is claimed is:

1. A system and method for objective quantification and mitigation of bias within at least one dataset, the system comprising:
a processor executing one or more engines coupled to an input-output (IO) interface for receiving at least one input dataset and a configuration file governing at least one specification of the at least one input dataset;
a data modelling engine configured to extract information about the at least one input dataset;
a bias quantification engine configured to quantify levels of bias across both single columns and combinations of multiple columns in the at least one input dataset based on the identified or configured bias target fields and a configured decision or outcome fields;
an encoding quantification engine configured to quantify levels of information encoding across the at least one input dataset based on the identified or configured bias target fields;
a scoring engine configured to produce row-level, column-level, and / or dataset-level bias scores, and calculate an overall magnitude and direction of mitigation actions to be taken for each row, column, and/or cell in the at least one input dataset;
an optimized bias mitigation engine configured to mitigate detected biases within the at least one input dataset while minimizing a loss of utility in the at least one input datasets; and
producing an output report.

2. The method of claim 1, wherein the mitigating includes employing various techniques to mitigate the bias.

3. The method of claim 2, wherein a technique includes removing rows which contribute to high bias.

4. The method of claim 2, wherein a technique includes changing values that contribute to high bias.

5. The method of claim 2, wherein a technique includes synthesizing additional rows to reduce the detected bias to below a threshold.

6. The method of claim 1, wherein the outputting occurs on a condition that the levels of bias have been sufficiently reduced below a configured threshold.

7. The method of claim 1, wherein the outputting occurs on a condition that the levels of bias have been reduced by iteratively processing in the system.

8. The method of claim 1 for automatic detection and mitigation of bias in data.

9. The method of claim 1 wherein the at least one specification includes at least one of bias scoring and bias mitigation setting.

10. The method of claim 1, wherein a sensitive field detection engine is configured to identify varying types of sensitive data by scanning the at least one input dataset for columns containing fields that may indicate the potential presence of bias within the at least one input dataset.

11. The method of claim 10, wherein the sensitive field detection engine Includes one or more field detection sub-routines.

12. The method of claim 1 wherein the extracted information is configured to determine levels of utility and guiding mitigation actions.

13. The method of claim 1 wherein the extracted information includes at least one of logical, mathematical and statistical characteristics.

14. The method of claim 1 wherein mitigating detected biases includes any combination of: under-sampling or deletion, over-sampling or synthesis, and/or value modification.

15. The method of claim 1 wherein quantifying levels of information encoding across includes both single columns and combinations of multiple columns across the at least one input dataset.

16. The method of claim 1 wherein the report includes at least one identified bias target.

17. The method of claim 1 wherein the report includes at least one potential source and level of bias propensity detected in the at least one input dataset.

18. The method of claim 1 wherein the report includes potential sources and levels of bias encoding detected in the at least one input dataset.

19. The method of claim 1 wherein the report includes the overall bias scores for the at least one input dataset.

20. The method of claim 1 wherein the report includes at least one mitigation action.
